(19) United States
(12) Patent Application Publication
(10) Pub. No.: US 2009/0153686 A1
(43) Pub. Date: Jun. 18, 2009

(54) INTERACTIVE SYSTEM AND METHOD FOR CONTROLLING A CAMERA WITH A MOBILE PHONE

(75) Inventor: Chi-Jen HUANG, Wugu Shiang (TW)

Correspondence Address: EGBERT LAW OFFICES, 412 MAIN STREET, 7TH FLOOR, HOUSTON, TX, 77002, US

(73) Assignee: INVENTEC APPLIANCES Corp., Wugu Shiang (TW)

(21) Appl. No.: 12/336,933

(22) Filed: Dec. 17, 2008

(30) Foreign Application Priority Data
Dec. 18, 2007 (TW) 096148533

(51) Int. Cl. H04N 5/232

(52) U.S. Cl. 348/211.2; 455/41.3; 348/E05.042

(57) ABSTRACT

An interaction system and method for controlling a camera with a mobile phone are disclosed. The interaction system includes a camera device and a mobile phone device. The camera device in a first operating mode is capable of capturing a first image data. The mobile phone device is provided with an operating platform having an application program installed thereon to provide a control interface. The first image data is transmitted to the mobile phone device via a transmission module of the camera device; and, based on the first image data, the control interface is operated via an operating module of the mobile phone device to thereby generate a control signal. With the control signal, the camera device is switched from the first operating mode to a second operating mode for capturing a second image data, which is then transmitted to the mobile phone device via the transmission module.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates to an interactive system and method for controlling a camera with a mobile phone; and more particularly to an interactive system and method for controlling a camera with a mobile phone, in which a control program is installed on a mobile phone device, and a camera device captures and sends a first image data to the mobile phone device for adjustment and then capture a second image data according to the adjusted first image data.

2. Description of Related Art Including Information Disclosed Under 37 CFR 1.97 and 37 CFR 1.98

To general users, a digital camera is very convenient because the digital camera provides largely upgraded image quality and is able to display image data on a monitor display before and after shooting a picture. However, with the currently commercially available digital cameras, a user wishing to take a picture of himself can only hold and direct the digital camera toward the user when there is nobody nearby to help in taking the picture. Under this situation, the user is not able to see his image via the monitor display on the digital camera and the shooting distance is largely restricted to thereby adversely affect the image effect. As to a digital camera with built-in Bluetooth transmission function, the Bluetooth function only allows the pictures taken to be transmitted to a personal digital assistant (PDA), a computer, or other Bluetooth devices without providing any mechanism for interacting with the digital camera. A user can generally use a remote controller to remotely control a particular digital camera. Therefore, the currently digital cameras have limited extension ability and a narrow range of applications.

FIG. 1 shows a prior art digital camera 1 with a detachable monitor display, and the detached monitor display functions as a device for remotely controlling the digital camera. As shown, the conventional digital camera 1 comprises a main body 1 1, a monitor display 12, and a motor unit 13. The monitor display 12 comprises a remote control circuit. When the monitor display 12 is detached from the main body 11, the remote control circuit may be used to wirelessly control and operate the digital camera 1. When the monitor display 12 is connected to the main body 11, it functions like a general monitor display, and the digital camera 1 returns to a general operating mode. The motor unit 13 comprises a small-scale motor, which enables the main body 11 to respond to a wireless control signal generated by the detached monitor display 12, so that the wireless control signal can orient the main body 11 toward different directions for aiming the lens of the digital camera 1 at a desired subject.

The above-described prior art digital camera 1 cannot be controlled and operated with a mobile phone. And, the currently available mobile phones do not include an operating platform for installing various camera control programs for controlling a digital camera with a mobile phone. Meanwhile, in the prior art digital camera 1, the wireless control signal can only orient the main body 11 toward different directions without other functions for adjusting the digital camera 1, such as adjusting the aperture value or shutter speed for the digital camera 1.

It is therefore tried by the inventor to develop an interactive system and method for controlling a camera with a mobile phone, so as to satisfy general users' demands for digital cameras interactive with mobile phones.

### BRIEF SUMMARY OF THE INVENTION

An aspect of the present invention is to provide an interactive system and method for controlling a camera with a mobile phone having at least one camera controlling application program installed thereon. With the present invention, the camera captures a first image data and sends the same to the mobile phone, the mobile phone adjusts the camera based on the first image data, and then, the camera captures a second image data and sends the same to the mobile phone. Therefore, the mobile phone can interact with the camera to achieve the purpose of controlling a camera with a mobile phone as demanded by users. The mobile phone comprises an operating platform, on which an application program is installed to provide a control interface, so that the functions of the camera may be adjusted from the mobile phone and images captured by the camera may be shown on a display of the mobile phone.

To achieve the above and other aspects, the interactive system for controlling a camera with a mobile phone according to the present invention comprises a camera device and a mobile phone device. The camera device has a first operating mode and comprises a transmission module. The camera device in the first operating mode is capable of capturing a first image data. The mobile phone device comprises an operating platform and an operating module. At least one application program is installed on the operating platform to provide a control interface. The first image data is transmitted via the transmission module of the camera device to the mobile phone device; and, based on the first image data, the control interface may be operated via the operating module of the mobile phone device to thereby generate a control signal. With the control signal, the camera device may be switched from the first operating mode to a second operating mode for capturing a second image data. The second image data is then transmitted to the mobile phone device via the transmission module of the camera device.

And, the interactive method for controlling a camera with a mobile phone according to the present invention comprises the following steps:
(a) setting up an operating platform on a mobile phone device, and installing an application program on the operating platform to provide a control interface;
(b) setting a camera device to a first operating mode to capture a first image data;
(c) transmitting the first image data via a transmission module of the camera device to the mobile phone device;
(d) generating a control signal according to the first image data by operating the control interface via an operating module of the mobile phone device;
(e) switching the camera device from the first operating mode to a second operating mode according to the control signal;
(f) capturing a second image data by the camera device in the second operating mode;
(g) transmitting the second image data via the transmission module of the camera device to the mobile phone device; and
(h) editing the second image data on the mobile phone device in a desirable manner and saving the edited second image data.

### BRIEF DESCRIPTION OF THE SEVERAL VIEWS OF THE DRAWINGS

The structure and the technical means adopted by the present invention to achieve the above and other aspects can be best understood by referring to the following detailed description of the preferred embodiments and the accompanying drawings.

FIG. 1 shows a schematic view of a prior art digital camera with a detachable monitor display, wherein the detached monitor display functions as a device for remotely controlling the digital camera.

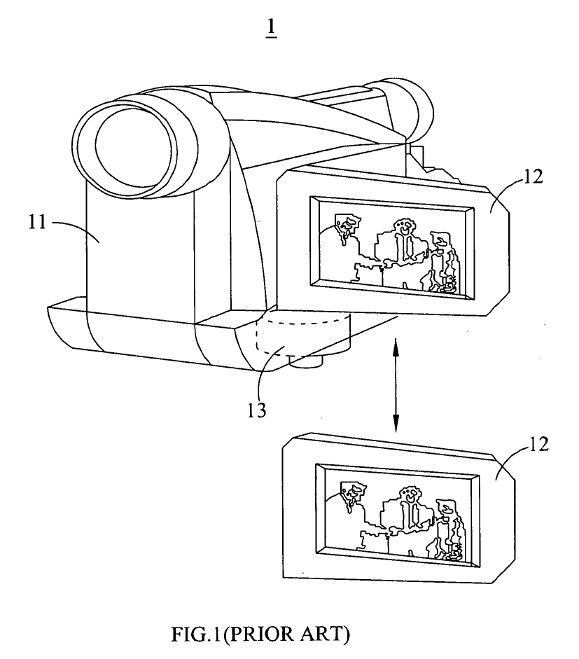

FIG. 2 is a schematic view of an illustration of an interactive system for controlling a camera with a mobile phone according to an embodiment of the present invention.

FIG. 3 is another illustration, showing a flowchart with the steps of an interactive method for controlling a camera with a mobile phone according to an embodiment of the present invention.

### DETAILED DESCRIPTION OF THE INVENTION

The present invention will now be described with some preferred embodiments thereof. For the purpose of easy to understand, elements that are the same in the preferred embodiments are denoted by the same reference numerals.

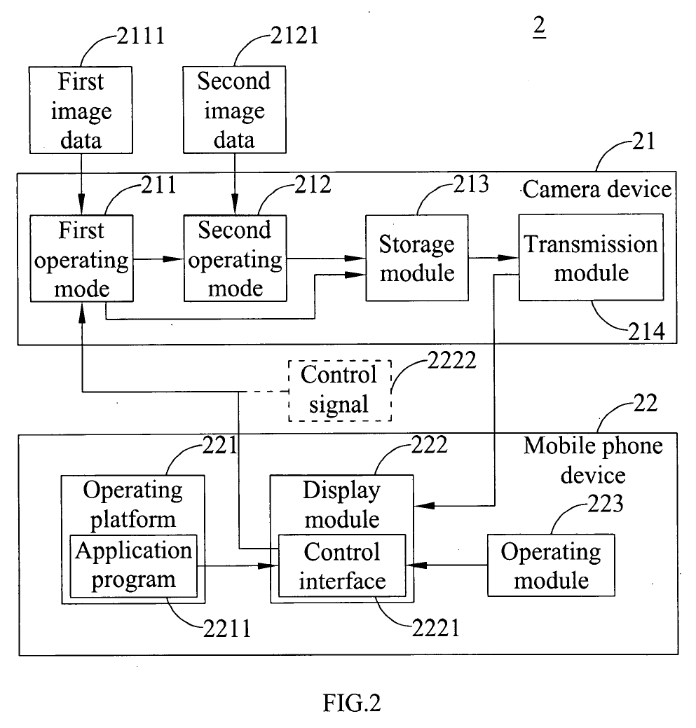

Referring to FIG. 2, there is a conceptual view of an interactive system 2 for controlling a camera with a mobile phone according to an embodiment of the present invention. As shown, the interactive system 2 comprises a camera device 21 and a mobile phone device 22. The camera device 21 has a first operating mode 211 and comprises a transmission module 214. In the first operating mode 211, the camera device 21 may capture a first image data 2111. The camera device 21 may be a traditional camera, a digital camera, or a video camera. The transmission module 214 may enable Bluetooth transmission or infrared transmission. The mobile phone device 22 comprises an operating platform 221, a display module 222, and an operating module 223. At least one application program 2211 is installed on the operating platform 221, and the application program 2211 comprises a control program for controlling the camera device 21, so that the application program 2211 provides a control interface 2221. The application program 2211 may be upgraded when any updated or newest version of the application program 2211 is released, so that the control interface 2221 may always have most recently updated function. The operating platform 221 may be an operating system, such as, for example, Windows Mobile, Linux, or Symbian. The display module 222 is used to show the control interface 2221, the first image data 2111, and a second image data 2121 thereon. The operating module 223 may be a stylus, a finger, or a key pad.

The transmission module 214 of the camera device 21 transmits the first image data 2111 to the mobile phone device 22, and the transmitted first image data 2111 is shown on the display module 222 of the mobile phone device 22. Therefore, based on the first image data 2111, a user may operate the control interface 2221 via the operating module 223 to generate a control signal 2222. With the control signal 2222, the camera device 21 may be switched from the first operating mode 211 to a second operating mode 212 and driven to operate in the second operating mode 212 to capture a second image data 2121. The second image data 2121 is then transmitted via the transmission module 214 to the mobile phone device 22. The control signal 2222 is able to adjust at least one of the items of turning direction, shooting mode, flash mode, focusing range, aperture value, shutter speed, shooting time, and exposure time for the camera device 21. The camera device 21 may capture the first image data 2111 and the second image data 2121 via an image capturing module. And, the camera device 21 may further comprise a storage module 213 for storing the first image data 2111 and the second image data 2121 thereon.

The display module 222 of the mobile phone device 22 may be a touch screen. A user may edit the first image data 2111 or the second image data 2121 on the display module 222, such as providing a hand-drawn pattern or a hand-written character on the first or the second image data, via the operating module 223. The user may also use the operating module 223 to provide the first image data 2111 or the second image data 2121 with photo information, such as a file name, a person name, a place name, and/or other notes. The user may also use the operating module 223 to sort out the first image data 2111 and the second image data 2121. The sorting may be effected in the camera device 21 via a type of signal transmission corresponding to that of the camera device 21 or be effected directly in the mobile phone device 22, so that the user may conveniently and quickly locate any desired image data. The mobile phone device 22 may also transmit the first image data 2111 and the second image data 2121 to other electronic devices, such as a computer, a PDA, another mobile phone device, or the like. Moreover, the mobile phone device 22 may further comprise an audio recording module (not shown) to provide an audio recording function. The user may record a piece of audio information for images or videos shot by the user to facilitate future sorting or browsing of the image data.

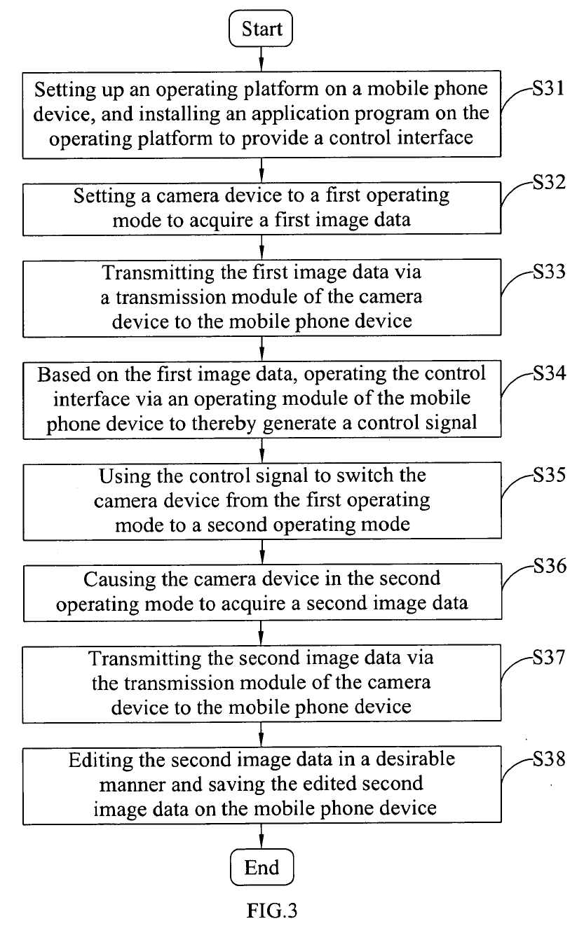

FIG. 3 is a flowchart showing the steps of an interactive method for controlling a camera via a mobile phone according to an embodiment of the present invention. The flowchart in the illustrated embodiment corresponds to the conceptual view of the interactive system for controlling a camera with a mobile phone shown in FIG. 2, and comprises the following steps:
Step S31, in which an operating platform 221 is set up on a mobile phone device 22, and an application program 2211 is installed on the operating platform 221 to provide a control interface 2221;
Step S32, in which a camera device 21 is set to a first operating mode 211 to capture a first image data 2111;
Step S33, in which the first image data 2111 is transmitted via a transmission module 214 of the camera device 21 to the mobile phone device 22;
Step S34, in which a control signal 2222 is generated according to the transmitted first image data 2111 by operating the control interface 2221 via the operating module 223;
Step S35, in which the control signal 2222 is capable of switching the camera device 21 from the first operating mode 211 to a second operating mode 212 by adjusting at least one of the items of turning direction, shooting mode, flash mode, focusing range, aperture value, shutter speed, shooting time, and exposure time for the camera device 21;
Step S36, in which a second image data 2121 is captured by the camera device 21 in the second operating mode 212;
Step S37, in which the second image data 2121 is transmitted via the transmission module 214 of the camera device 21 to the mobile phone device 22; and
Step S38, in which the second image data 2121 is edited via the operating module 223 of the mobile phone device 22 in a desirable editing manner, such as, for example, using a hand drawing function of the mobile phone device 22 to edit messages related to the second image data 2121 or inputting a file name for the second image data 2121, and then, the edited second image data is filed and saved.

It is noted, in the interactive method for controlling a camera with a mobile phone according to the present invention, the camera device 21 may be a traditional camera, a digital camera, or a video camera. The operating platform 221 may be an operating system, such as, for example, Windows Mobile, Linux, or Symbian. The application program 2211 may comprise a control program for controlling the camera device 21. Meanwhile, the mobile phone device 22 has a display module 222 for showing the control interface 2221, the first image data 2111, and the second image data 2121 thereon. The display module 222 may be a touch screen, on which the first image data 2111 or the second image data 2121 may be edited, such as providing a hand-drawn pattern or a hand-written character on the first or the second image data, via the operating module 223. The operating module 223 may be a stylus, a finger, or a key pad. The operating module 223 may also be capable of providing the first image data 2111 or the second image data 2121 with photo information, such as a file name, a person name, a place name, and/or other notes, to sort out the first image data 2111 and the second image data 2121, and save the edited first or second image data in the camera device 21 or the mobile phone device 22, so that the user may conveniently and quickly locate any desired image data. The camera device 21 further comprises a storage module 213 for storing the first image data 2111 or the second image data 2121. The mobile phone device 22 further comprises an audio recording module to provide an audio recording function, allowing a user to record a piece of audio information for images or videos shot by the user to facilitate future sorting or browsing of the image data. The transmission module 214 may enable Bluetooth transmission or infrared transmission. Moreover, the mobile phone device 22 may also transmit the first image data 2111 and the second image data 2121 to other electronic devices, such as a computer, a PDA, another mobile phone device, or the like.

1. An interactive system for controlling a camera with a mobile phone, comprising:
a camera means for capturing a first image data in a first operating mode; and
a control means, being comprised of a mobile phone and having an operating platform, an operating module and a display module, the operating platform having at least one application program installed thereon,
wherein the first image data is transmitted to the mobile phone device via a transmission module of the camera means, the display module showing the first image and the control interface, based on the first image data, the control interface being operated via the operating module to generate a control signal, the camera device being switched from the first operating mode to a second operating mode by the control signal and capturing a second image data in the second operating mode, the second image data being then transmitted via the transmission module to the mobile phone device and showed on the display module.

2. The interactive system for controlling a camera with a mobile phone as claimed in claim 1, wherein the camera means is switched from the first operating mode to the second operating mode according to the control signal by adjusting turning direction, shooting mode, flash mode, focusing range, aperture value, shutter speed, shooting time, or exposure time for the camera device.

3. The interactive system for controlling a camera with a mobile phone as claimed in claim 1, wherein the transmission module enables a transmission manner selected from the group consisting of Bluetooth transmission and infrared transmission.

4. The interactive system for controlling a camera with a mobile phone as claimed in claim 1, wherein the operating module is selected from the group consisting of a stylus, a finger, and a key pad.

5. The interactive system for controlling a camera with a mobile phone as claimed in claim 1, wherein the operating module provides photo information to the first image data or the second image data.

6. The interactive system for controlling a camera with a mobile phone as claimed in claim 1, wherein the first image data and the second image is sorted and saved in the camera device or the mobile phone device by the operating module.

7. The interactive system for controlling a camera with a mobile phone as claimed in claim 1, wherein the display module of the mobile phone device is a touch screen, on which the first image data or the second image data is edited via the operating module.

8. The interactive system for controlling a camera with a mobile phone as claimed in claim 1, wherein the mobile phone device further comprises an audio recording module for providing an audio recording function.

9. The interactive system for controlling a camera with a mobile phone as claimed in claim 1, wherein the application program comprises a control program for controlling the camera device.

10. An interactive method for controlling a camera with a mobile phone, comprising the steps of:
(a) setting up an operating platform on a mobile phone device, and installing an application program on the operating platform to provide a control interface;
(b) setting a camera device to a first operating mode to capture a first image data;
(c) transmitting the first image data via a transmission module of the camera device to the mobile phone device;
(d) generating a control signal according to the first image data by operating the control interface via an operating module of the mobile phone device;
(e) switching the camera device according to the control signal from the first operating mode to a second operating mode;
(f) capturing a second image data by the camera device in the second operating mode to; and
(g) transmitting the second image data via the transmission module of the camera device to the mobile phone device.

11. The interactive method for controlling a camera with a mobile phone as claimed in claim 10, further comprising a step (h) after the step (g):
editing the second image data on the mobile phone device in a desirable manner and saving the edited second image data.

12. The interactive method for controlling a camera with a mobile phone as claimed in claim 10, wherein the camera device is switched from the first operating mode to the second operating mode according to the control signal by adjusting turning direction, shooting mode, flash mode, focusing range, aperture value, shutter speed, shooting time, or exposure time for the camera device.

13. The interactive method for controlling a camera with a mobile phone as claimed in claim 10, wherein the transmission module enables a transmission manner selected from the group consisting of Bluetooth transmission and infrared transmission.

14. The interactive method for controlling a camera with a mobile phone as claimed in claim 10, wherein the operating module is selected from the group consisting of a stylus, a finger, and a key pad.

15. The interactive method for controlling a camera with a mobile phone as claimed in claim 10, wherein the operating module provides photo information to the first image data or the second image data.

16. The interactive method for controlling a camera with a mobile phone as claimed in claim 10, wherein the first image data and the second image is sorted and saved in the camera device or the mobile phone device by the operating module.

17. The interactive method for controlling a camera with a mobile phone as claimed in claim 10, wherein the mobile phone device further comprises an audio recording module for providing an audio recording function.

18. The interactive method for controlling a camera with a mobile phone as claimed in claim 10, wherein the application program comprises a control program for controlling the camera device.
